(19) United States
(12) Patent Application Publication
(10) Pub. No.: US 2005/0158613 A1
(43) Pub. Date: Jul. 21, 2005

(54) Power doubling battery system

(76) Inventors: Tzu-Shan Liu, Yung-He City (TW); Shin-Hang Chou, Nan-Tou Hsien (TW)

Correspondence Address: Leong C. Lei;PMB#1008, 1867 Ygnacio Valley Rd., Walnut Creek, CA, 94598-3214, US

(21) Appl. No.: 11/032,124

(22) Filed: Jan. 11, 2005

(30) Foreign Application Priority Data
Jan. 16, 2004 (TW) 093101264

(51) Int. Cl. H01M 10/42; H01M 2/08

(52) U.S. Cl. 429/61; 429/185; 429/7; 429/149

(57) ABSTRACT

A battery system that has a doubled power supply than the conventional ones is provided. The battery of the invention has a first, a second, and a third electrode plates, each of which is electrically connected to electrodes on the housing of the battery via a first, a second, and a third conducting poles respectively. A first and a second separation plates are interposed between the first and the second electrode plates, and between the second and the third electrode plates respectively. The system utilizes a control to switch between the conduction between the first and the second conducting poles, and the conduction between the second and the third conducting poles.

### BACKGROUND OF THE INVENTION

(a) Technical Field of the Invention

The present invention generally relates to batteries and, more particularly, to a system of batteries having three electrode plates for doubling their power supply performance.

(b) Description of the Prior Art

Currently most electric motor vehicles, for cost reduction sake, usually use a lead-acid battery for supplying electricity to the motor. Conventional lead-acid batteries, whose outlook is depicted in FIG. 6, contain only two electrode plates for charging and discharging. The two electrode plates are immersed in the electrolyte contained in a reaction chamber with a separation plate, which allows only ions to pass through, interposed between the two electrode plates. The electrical power is generated by the reaction between the electrode plates and the electrolyte. The conventional lead-acid batteries have the following shortcomings.

First, the batteries could actually provide more power but, with only two electrode plates, the batteries' potential is not fully harnessed.

Secondly, when the batteries' power is exhausted, the batteries couldn't be re-charged automatically and a separate power source has to be used and a longer period of charging time is required.

Thirdly, since a separate power source is required, the batteries have to be moved to an appropriate place for charging, which adds to the inconvenience of the batteries.

With the above shortcomings of the conventional lead-acid batteries, electric motor vehicles couldn't be popularized, which indirectly causes the slow replacement of fuel-based motor vehicles and delays the recovery of the ecological environment.

Accordingly, there is an urgent need for a better battery so that the foregoing shortcomings of conventional batteries could be obviated.

### SUMMARY OF THE INVENTION

The primary purpose of the present invention is to provide a battery system that has a doubled power supply than the conventional lead-acid batteries. The battery of the present invention has a first, a second, and a third electrode plate, each of which is electrically connected to conducting contacts on the housing of the battery via a first, a second, and a third conducting poles respectively. A first and a second separation plates are interposed between the first and the second electrode plates, and between the second and the third electrode plates respectively. The system utilizes a control unit to switch between the conduction between the first and the second conducting poles, and the conduction between the second and the third conducting poles.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective schematic diagram showing the structure of a battery according to a preferred embodiment of the present invention.

FIG. 2 is a schematic diagram showing the interaction of the components of a control unit according to a preferred embodiment of the present invention.

FIG. 3 is a schematic diagram showing the interaction of the components of a control unit according to a preferred embodiment of the present invention.

FIG. 4 is a perspective schematic diagram showing the structure of the control unit according to a preferred embodiment of the present invention.

FIG. 5 is a perspective schematic diagram showing the outlook of a battery according to a preferred embodiment of the present invention.

FIG. 6 is a perspective schematic diagram showing the outlook of a conventional lead-acid battery.

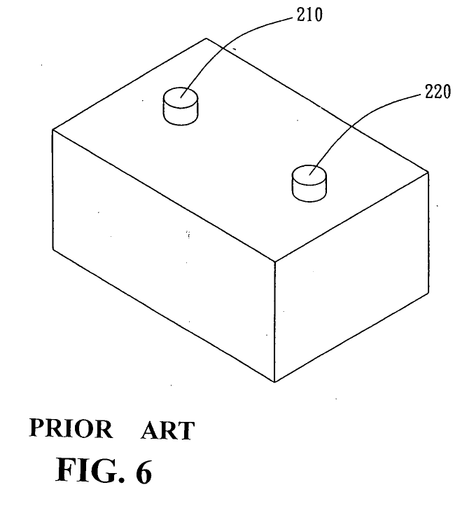

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

In the following, detailed description along with the accompanied drawings is given to better explain preferred embodiments of the present invention. Please note that some parts of the accompanied drawings are not drawn to scale or are somewhat exaggerated. It should be understood that this is for illustrative purpose and is not intended to limit the presentation in any way.

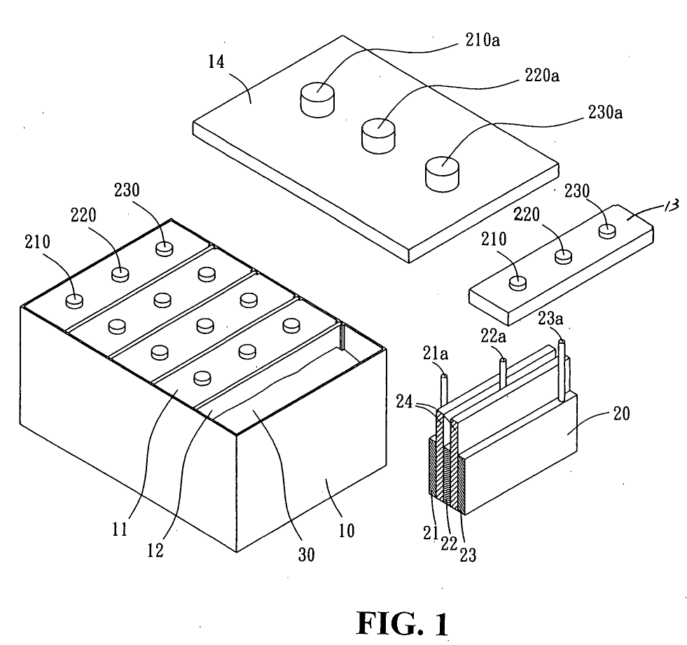

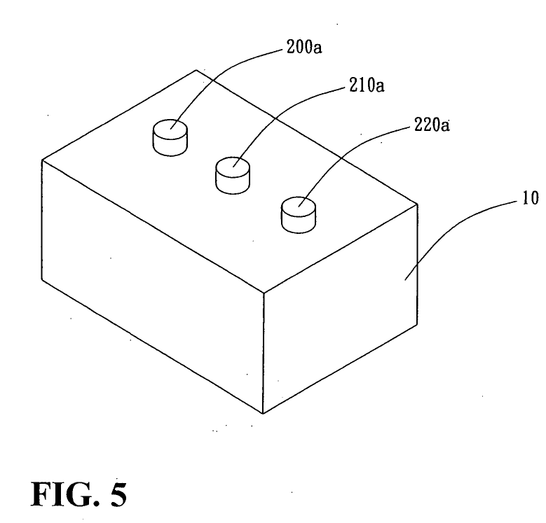

Please refer to FIGS. 1 and 5, which are perspective, schematic diagrams showing the structure and the outlook of a battery according to a preferred embodiment of the present invention. The battery according to the present embodiment has housing 11, which contains one or more reaction chambers 12 filled with electrolyte 30. Within each reaction chamber 12, an electrode device 20 is immersed in the electrolyte 30. The electrode device 20 further contains a first electrode plate 21 electrically connected to a first conducting pole 21a, a second electrode plate 22 electrically connected to a second conducting pole 22a, and a third electrode plate 23 electrically connected to a third conducting pole 23a. In addition, there is a first separation plate 24 interposed between the first and the second electrode plates 21 and 22, and there is a second separation plate 24 interposed between the second and the third electrode plates 22 and 23. The battery provided by the present embodiment further contains a control unit switches and controls the conduction between the first and the second conducting poles 21a and 22a, and the conduction between the second and the third conducting poles 22a and 23a.

As shown in FIGS. 1 and 5 of the present embodiment, the chambers 12 could be sealed by chamber covers 13, each of which has a first, a second, and a third conducting contacts 210, 220, and 230, which in turn electrically connects to the first, the second, and the third conducting poles 21a, 22a, and 23a respectively.

Again as shown in FIGS. 1 and 5 of the present embodiment, the housing 11 has an outer cover 14, which has a first, a second, and a third conducting contact 210a, 220a, and 230a. The housing 11's first conducting contact 210a is electrically connected to every first conducting contact 210 of all chamber covers 13. The housing 11's second conducting contact 220a is electrically connected to every second conducting contact 220 of all chamber covers 13. The housing 11's third conducting contact 230a is electrically connected to every third conducting contact 230 of all chamber covers 13.

In the present embodiment, the first electrode plate 21 works as an anode, the third electrode plate 23 works as a cathode, and the second electrode plate 22 works both as an anode and a cathode.

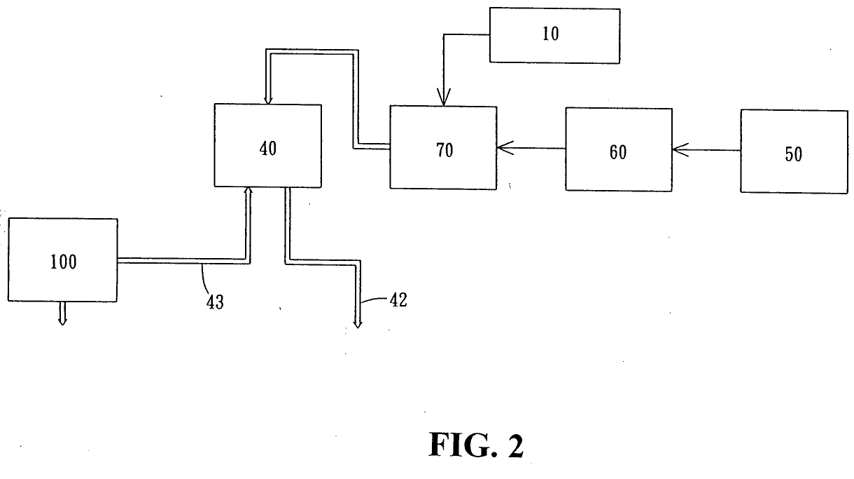

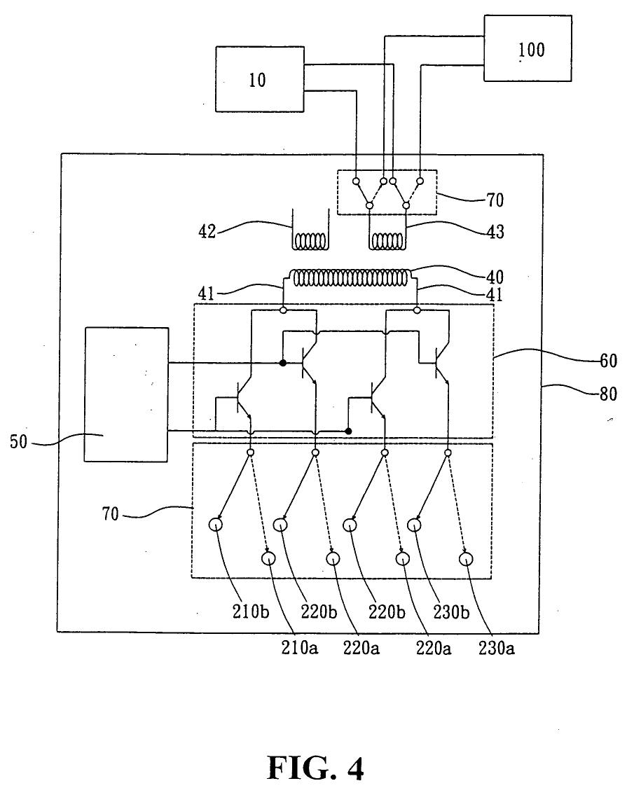

FIGS. 2, 3, and 4 are schematic diagrams showing the operation and structure of the control unit 80 according to a preferred embodiment of the present invention. The control unit 80 contains a transforming device 40, a control circuit 50, a driving circuit 60, and a switching device 70. The control unit 80 works with two batteries 10 and 100 according to the present embodiment, as depicted in FIGS. 1 and 5. The first, second, and third conducting contacts 210a, 220a, 230a of the battery 10 are electrically connected to separate connection points (not numbered) of switching device 70 respectively (shown in the bottom half of FIG. 4). Similarly, the first, second, and third conducting contacts 210b, 220b, 230b of the battery 100 are electrically connected to separate connection points (not numbered) of the switching device 70 respectively (also shown in the bottom half of FIG. 4). The switching device 70 is electrically connected to the driving circuit 60, which in turn is electrically connected to the control circuit 50. The transforming device 40 has an input side 41, an output side 42, and feedback side 43. The output side 42 is to provide electrical power to the load of the battery system. The feedback side 43 is electrically connected to the switching device 70 (shown in the upper half of FIG. 4), which switches between the first and second conducting contacts 210a, 220a of the battery 10, and the first and second conducting contacts 210b, 220b of battery 100. In this way, while battery 10 is discharging, the battery 100 could be re-charged at the same time and, while battery 100 is discharging, the battery 10 could be re-charged simultaneously. In other words, the battery system according to the present embodiment does not require a separate power source for re-charge; the battery system according to the present embodiment could re-charge itself automatically. With the switching device 70's control and with the control circuit 50's trigger to the driving circuit 60, the transforming device 40's input side 41 could be electrically connected to either the conducting contacts 210a, 220a, and 230a of the battery 10, or the conducting contacts 210b, 220b, and 230b of the battery 100, so as to double the power supply of the battery system of the present embodiment.

Please note that the control unit 80 triggers the driving circuit 60 in such a way that it first establishes conduction between the first conducting contact 210a and the second conducting contact 220a, it then breaks the conduction and establishes another conduction between the second conducting contact 220a and the third conducting contact 230a, and, repeatedly in this fashion, the control unit 80 switches back and forth between the two conductions.

Please also note that the conducting contacts 210a, 220a, 230a of the battery 10, and the conducting contacts 210b, 220b, 230b of the battery 100 are in series connection so as to increase the battery system's power output.

In the present embodiment, as shown in FIG. 4, the switching device 70 could contain a number of switches.

In the present embodiment, the first and the second electrode plates 21 and 22 could be made of lead (Pb), lead oxide (PbO), or lead sulfate. The third electrode plate 23 could be a carbon fiber plate with carbon as a constituent, a plate made of lead sulfate with carbon added, or a porous graphite plate.

In the present embodiment, the electrolyte 30 contained in the chambers 12 could be sulfuric acid (H₂SO₄) or silicic acid (H₂SiO₃).

In the present embodiment, the transforming device 40 is a transformer. The battery of the present embodiment works as follows. The electrolyte 30 is a sulfuric acid (H₂SO₄) or a silicic acid (H₂SiO₃). The first electrode plate 21 is a lead plate and the second electrode plate 22 is a lead oxide plate. The first electrode plate 21's Pb combines with the SO₄ ions of the electrolyte 30 and discharges. The discharged energy decomposes the PbO of the second electrode plate 22 into charged Pb and O ions. The charged Pb ions combine with the SO₄ ions or O ions again to discharge again. Since the second electrode plate 22 works as an anode and the third electrode plate 23 as a cathode, H ions move from the first electrode plate 21 toward the third electrode plate 23 and receive the discharged energy to combine into H molecules and complete the second discharge. As the battery discharges, the first electrode plate 21 and the second electrode plate 22 would be oxidized into PbSO₄ or PbO₂. After the battery is re-charged, the first electrode plate 21 would be reduced back to Pb and the second electrode plate 22 back to PbO or PbO₂.

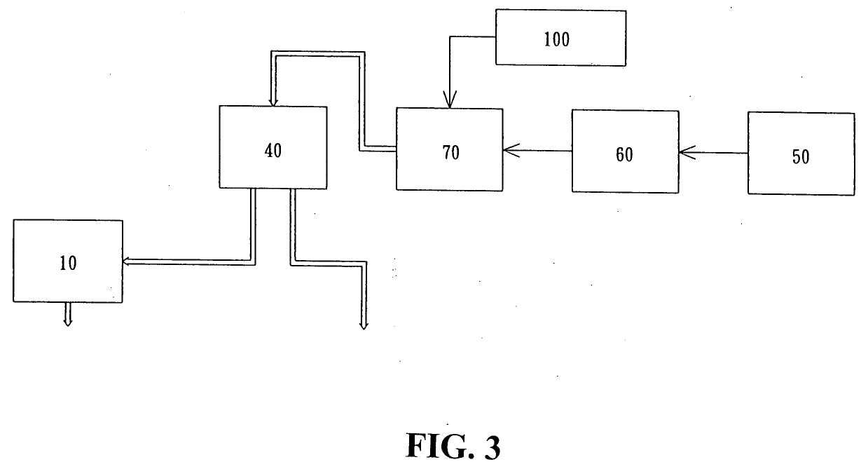

As shown in FIGS. 2 and 4, the battery system of the present embodiment works as follows. When the switching device 70 electrically connects the conducting contacts 210a, 220a, 230a of the battery 10 to the connection points of the driving circuit 60, the first electrode plates 21 and the second electrode plates 22 of the battery 10 begin to discharge. The control circuit 50 triggers the driving circuit 60 so that the input side 41 of the transforming device 40 electrically connects to the first and second conducting contacts 210a and 220a of the battery 10. The output side 42 of the transforming device 40 delivers electricity to the load (such as an electric motor) of the battery system. The feedback side 43 of the transforming device 40, on the other hand, delivers electricity via the switching device 70 to the first and second conducting contacts 210b and 220b of the battery 100 for re-charging. Similarly, when the control circuit 50 triggers the driving circuit 60 so that the input side 41 of the transforming device 40 electrically connects to the second and third conducting contacts 220a and 230a of the battery 10, the second and third electrode plates 22 and 23 of the battery 10 begin to discharge. The output side 42 of the transforming device 40 delivers electricity to the load (such as an electric motor) of the battery system. The feedback side 43 of the transforming device 40, once again, delivers electricity via the switching device 70 to the first and second conducting contacts 210b and 220b of the battery 100 for re-charging. Now please refer to FIGS. 3 and 4. When the battery 100 is fully re-charged, the switching device 70 electrically connects the conducting contacts 210b, 220b, and 230b of the battery 100 to the connection points of the driving circuit 60, the first electrode plates 21 and the second electrode plates 22 of the battery 100 begin to discharge. The control circuit 50 triggers the driving circuit 60 so that the input side 41 of the transforming device 40 electrically connects to the first and second conducting contacts 210b and 220b of the battery 100. The output side 42 of the transforming device 40 delivers electricity to the load (such as an electric motor) of the battery system. The feedback side 43 of the transforming device 40, on the other hand, delivers electricity via the switching device 70 to the first and second conducting contacts 210a and 220a of the battery 10 for re-charging. Similarly, when the control circuit 50 triggers the driving circuit 60 so that the input side 41 of the transforming device 40 electrically connects to the second and third conducting contacts 220b and 230b of the battery 100, the second and third electrode plates 22 and 23 of the battery 100 begin to discharge. The output side 42 of the transforming device 40 delivers electricity to the load (such as an electric motor) of the battery system. The feedback side 43 of the transforming device 40, once again, delivers electricity via the switching device 70 to the first and second conducting contacts 210a and 220a of the battery 10 for re-charging. Therefore, the battery system according to the present embodiment could automatically re-charge itself without a separate outside power source.

Based on the foregoing description, the present invention has the following advantages.

First, the battery has three electrode plates for charging and discharging and, thereby, is able to double its power supply. The battery system therefore has a much enhanced power supply performance and practicability.

Secondly, the battery system is able to re-charge itself without requiring a separate power source. The battery system requires less time to re-charge, which reduces its operation cost.

Thirdly, the battery system is not required to locate and move to a suitable place for re-charging. It is therefore much more convenient to use.

Lastly, the battery system, with its doubled power supply and convenience in use, could help to speed up the replacement of fuel-based motor vehicles with electric vehicles, which could gradually reduce the environmental pollution.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. A power doubling battery system comprising:
at least a battery, said battery further comprising:
a housing, which comprises at least a chamber filled with an electrolyte; and
an electrode device immersed in said electrolyte of each chamber, said electrode device further comprising:
a first electrode plate electrically connected to a first electrode pole;
a second electrode plate electrically connected to a second electrode pole;
a third electrode plate electrically connected to a third electrode pole;
a first separation plate interposed between said first and said second electrode plates; and
a second separation plate interposed between said second and said third electrode plates; and
a control unit, said control unit controlling a conduction between said first and said second electrode poles, and a conduction between said second and said third electrode poles, and said control unit switching between said two conductions.

2. The power doubling battery system according to claim 1, wherein said chamber is sealed by a chamber cover, which has a first, a second, and a third conducting contacts on top of said chamber cover; said first conducting contact is electrically connected to said first electrode pole; said second conducting contact is electrically connected to said second electrode pole; and said third conducting contact is electrically connected to said third electrode pole.

3. The power doubling battery system according to claim 1, wherein said housing is sealed by an outer cover; said outer cover has a first, a second, and a third conducting contacts on top of said outer cover; said first conducting contact of said outer cover is electrically connected to said first conducting contact of every said chamber cover; said second conducting contact of said outer cover is electrically connected to said second conducting contact of every said chamber cover; and said third conducting contact of said outer cover is electrically connected to said third conducting contact of every said chamber cover.

4. The power doubling system according to claim 1, wherein said control unit further comprises a transforming device, a control circuit, a driving circuit, and a switching device; said first, said second, and said third conducting contacts on said outer cover is electrically connected to separate connection points of said switching device respectively; said switching device is electrically connected to said driving circuit; said driving circuit is electrically connected to said control circuit; under the operation of said control circuit, said first, said second, and said third conducting contacts of said battery are electrically connected to an input side of said transforming device; said transforming device delivers electrical power to a load of said battery system via an output side of said transforming device; said transforming device has a feedback side which is electrically connected to said switching device; said transforming device delivers electrical power to another battery via said feedback side of said transforming device when said switching device switches said feedback side to said conducting contacts of said another battery.

5. The power doubling system according to claim 1, wherein said control unit functions such that a first conduction is established between said first conducting contact and said second conducting contact, then said first conduction is broken, then a second conduction is established between said second conducting contact and said third conducting contact, and then said control units repeatedly switches back and forth between said two conductions.

6. The power doubling system according to claim 1, wherein said third electrode plate is a carbon fiber plate with carbon as a constituent.

7. The power doubling system according to claim 1, wherein said third electrode plate is a plate made of lead sulfate with carbon added.

8. The power doubling system according to claim 1, wherein said third electrode plate is a porous graphite plate.

9. The power doubling system according to claim 1, wherein said transforming device is a transformer.

10. The power doubling system according to claim 1, wherein said switching device comprises at least a switch.

11. The power doubling system according to claim 1, wherein said electrolyte is sulfuric acid.
